(19) United States
(12) Patent Application Publication
(10) Pub. No.: US 2004/0070563 A1
(43) Pub. Date: Apr. 15, 2004

(54) Wearable imaging device

(76) Inventor: Ian Nevill Robinson, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 10/268,386

(22) Filed: Oct. 10, 2002

(51) Int. Cl. G09G 5/00

(52) U.S. Cl. 345/156

(57) ABSTRACT

An imaging device is disclosed that is portable and is adapted to be worn on or about the body of a user. The imaging device includes a light source that emits a beam of light and a scanning optical assembly for steering the light beam biaxially onto an external surface thereby generating an image. In one embodiment, the light beam is a laser. The image can be viewed on a variety of surfaces, e.g., a user's hand or tabletop. An interaction means can be included for interaction between the user and the projected image. The imaging device can communicate with external computing devices, such as, devices connected via a personal area network. The imaging device does not require the user to focus the image when projecting it onto surfaces having different distances. Power consumption of the imaging device is minimized.

### BACKGROUND OF THE INVENTION

Description of the Related Art

A variety of techniques are available for providing visual displays of graphical or video images to a user. Liquid crystal displays utilize display screens that are typically several inches across. However, such display have little practical use when the display is intended to occupy only a small portion of a user's field of view, when the display is intended to be worn by a user, or when a display is needed for use in a small physical device.

Previous solutions to the problem of creating a large virtual display from small physical devices have included head-mounted displays and micro-displays. These displays rely on the user wearing or holding a system having a small display and magnifying optics close to the user's eye. As such, these displays are cumbersome and intrusive. Also, these displays cannot be viewed by more than one person at a time, nor is the user able to directly interact with the display, i.e., point to elements on the display.

### SUMMARY OF THE INVENTION

The invention replaces the bulky imaging devices of electronic devices, such as a personal data assistants (PDA), with a smaller, lighter imaging device that can be easily worn by a user. The liquid crystal display (LCD) module in a PDA accounts for a significant portion of the devices bulk. The display of the present invention is able to present a full screen size of data without having to carry around a display of that size, e.g., an LCD module.

According to one embodiment of the invention, an imaging device is disclosed that is adapted to be worn on or about the body of a user. The imaging device comprises a light source, the light source emitting a light beam, and a scanner for steering the light beam, biaxially onto an external surface, projecting an image. An external surface is a surface other than the imaging device. The light beam is preferably a laser. The imaging device preferably comprises a power source, wherein the power source is a battery. Having a battery as a power source allows the imaging device to be conveniently portable and well as wearable for the user.

Advantages of using a laser as the light source in the present invention include the laser's high efficiency and the lack of a need to focus the image when projecting onto surfaces at different distances, e.g., onto the wearer's hand vs. a tabletop. In one embodiment the laser is modulated (e.g., turned on and off) directly to produce light and dark pixels, an advantage of which is that power is only expended to illuminate light pixels. Thus, power consumption can potentially be much less than, for example, a LCD projector where the light source is constantly on and dark pixels are created by blocking this light.

The imaging device can be used as a stand alone display connected to another device, e.g., the display can act as a display resource within a wirelessly connected personal area network made up of other devices such as a cell-phone, PDA, music player, etc. The present invention can also be used as a display component with another device, such as a cell-phone, PDA, etc.

These and other features, aspects, and advantages of the present invention will become better understood with regard to the following detailed description and accompanying drawings.

### BRIEF DESCRIPTION OF THE DRAWINGS

FIGS. 1a-b shows a person wearing the imaging device around his neck (FIG. 1a) and the projected image on the user's hand (FIG. 1b), according to an embodiment of the present invention;

FIG. 2 is a schematic illustration of a scanner, according to an embodiment of the present invention;

FIG. 3 illustrates an embodiment of the wearable imaging device showing interaction between the user and the imaging device, the device is mounted on the body of a user; and

FIG. 4 is a schematic illustration of the imaging device and data input device, according to an embodiment of the present invention.

### DETAILED DESCRIPTION OF THE INVENTION

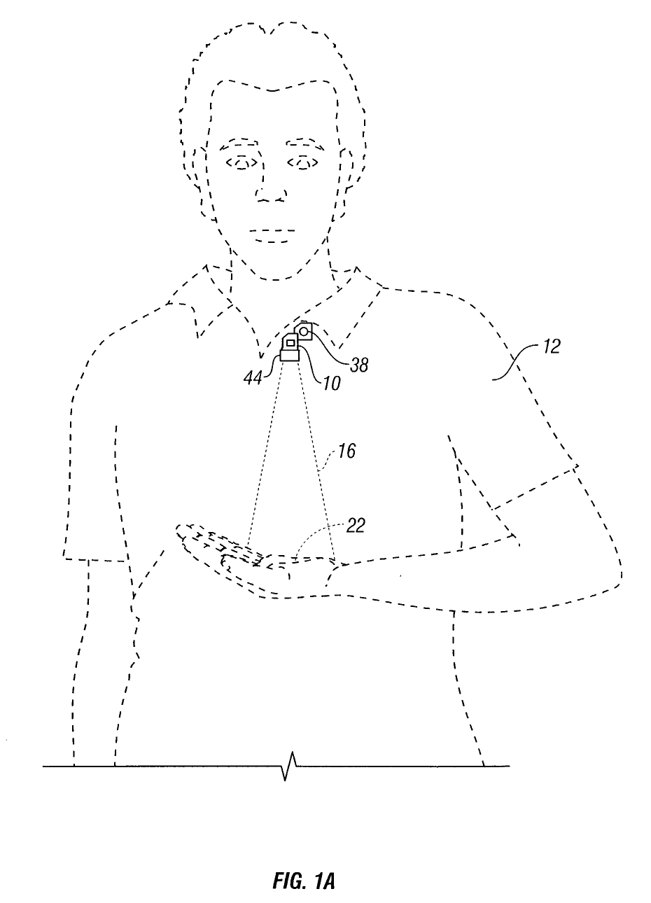

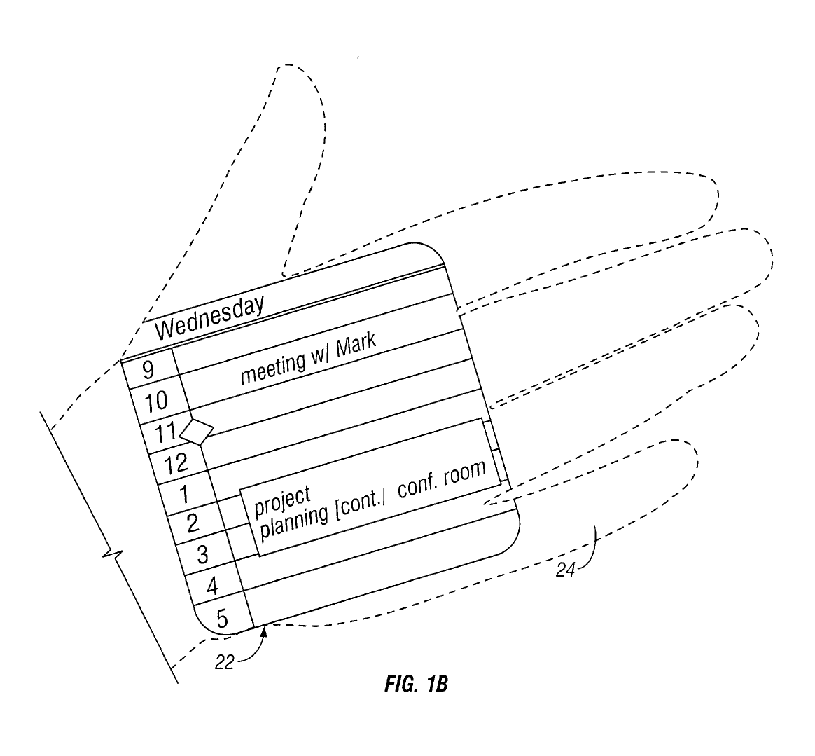

FIGS. 1-4 illustrate an embodiment of the imaging device 10 of the present invention. FIG. 1 illustrates an embodiment of the electronic imaging device 10 which is body-mounted and worn by a user 12. The imaging device 10 can also include housing 38. The imaging device 10 alone, or the imaging device 10 along with the housing 38 can also be incorporated in the user's clothing, on a fixed device, or otherwise remain in the user's presence, e.g., attached to a vehicle. The housing 38 can further include an optional belt loop, or clip to assist the user 12 in attaching the protective housing to clothing during outdoor activities such as walking, running, cycling, etc. The imaging device 10 may have no identifiable user 12, but rather operate as an independent probe, modeling and/or reporting on the context in an arbitrary location.

In one embodiment of the invention, the imaging device 10 is incorporated in housing 38 designed to be attached to the user's upper chest area, e.g., by clipping to a lapel and/or by hanging around the user's neck (FIG. 1a). In another embodiment of the imaging device 10, the device 10 includes a power source, such as a removable battery 44, and the device is in operative connection with the removable battery 44 for providing power. The battery 44 allows the imaging device 10 to be conveniently portable and well as wearable for the user 12.

The imaging device 10 is activated by tapping the device 10 or tapping a switch on the device 10, which turns on or off the power source 44. When the power source 44 is turned on the imaging device 10 projects an image 22 downwards onto the user's hand 24 or any other convenient surface 24, e.g., such as a tabletop. The image 22 also may be projected a light-colored glove 30 (not shown) or other light-colored wearable fabric worn by the user 12.

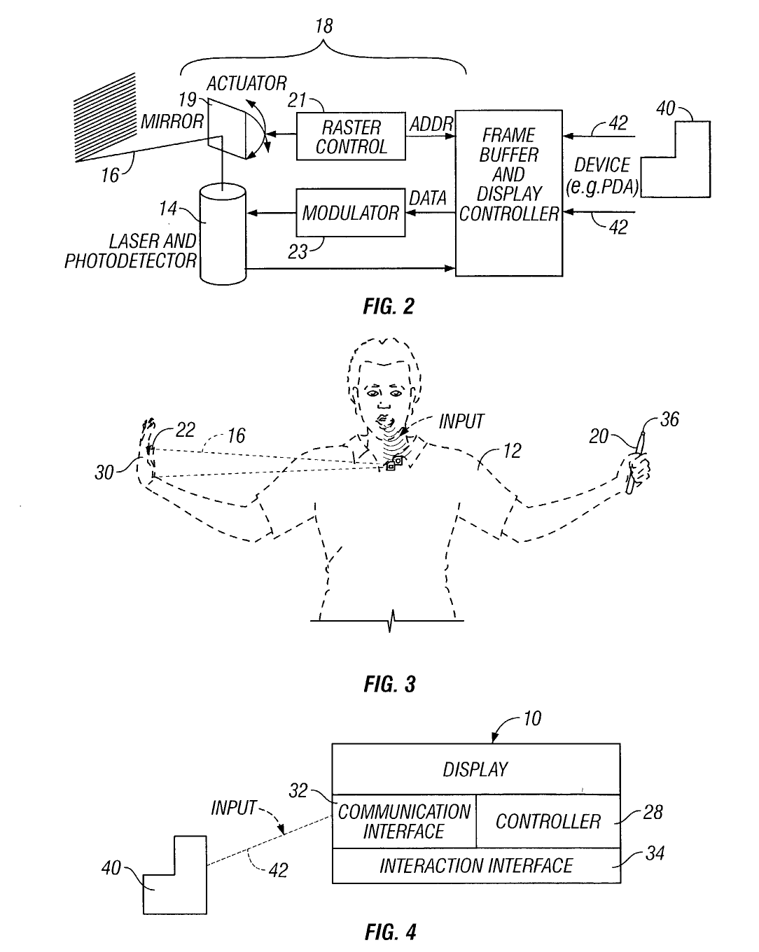

FIG. 1b shows image 22 projected onto an external surface 24. The image 22 (not shown) is generated when a light source 14 emits a beam of light 16 (not shown) which is then steered both vertically and horizontally by a scanner 18 onto an external surface 24 (not shown) (FIG. 2). In one embodiment of the invention, the light beam 16 is a laser beam. The light beam 16 is scanned both vertically and horizontally to create a raster by scanner 18. Scanner 18 comprises a scanning optical assembly 19, a raster control 21, a light source 14, and a modulator 23. In one example of a scanning optical assembly 19, the light beam 16 is bounced off of two mirrors in sequence, where each mirror scans the light beam 16 in one direction. For example, the first mirror scans the light beam 16 quickly from side to side, while the second mirror sweeps the light beam 16 more slowly from top to bottom, such that each horizontal sweep is performed slightly below the previous sweep, creating a raster of lines. By using a scanning optical assembly 19 having a mirror hinged on both axes (FIG. 2), it is possible to combine the horizontal and vertical scanning functions into one optical element, thus simplifying the design of the scanning mirror assembly 19 and reducing the number of moving parts.

The light beam 16 is modulated to create light and dark pixels within this raster pattern. When the displayed image 22 is a simple screen of light text on a dark background, the duty cycle of the laser 16 is low, about 25% on and about 75% off. Other means for scanning the beam 16 is through the use of any vibrating or rotating optical assemblies capable of deflecting light, e.g., a rotating drum with mirrored facets or a vibrating micro-electro-mechanical system (MEMS) device.

In another embodiment, the imaging device 10 includes a frame buffer 27 and display controller 28. The scanner 18 of the display 10 includes an interaction interface 34 for interacting between the user 12 and the display device 10. A pointer or stylus 20 having a retro-reflective spot 36 at its end, or a retro-reflective dot 36 applied to the user's 12 fingernail, when placed with in the projected image 22, will reflect the scanned light beam 16 back along its projected path when the light beam 16 touches it. The presence of a returned beam 16 can be detected by splitting it off with a half-silvered mirror just before the light source 14 and directing it to the light source and photo-detector 14. Since the display controller 28 knows the position of the light beam 16, as input from the raster control 21, that position can be reported when a reflected beam 16 is detected. This method of interaction between the user 12 and the display 10 only works on portions of the projected image that are lit, which is sufficient for buttons and other user interface icons and controls. If interaction is needed on a predominantly blank screen, the display 10 can be made to project a grid of small dots so that the retro-reflective spot 36 can reflect the scanned light beam 16 back. The interaction interface 34 may also allow audio interaction between the user 12 and the display device 10

Another embodiment of the imaging device 10 includes a communication interface 32 which can receive data 42, particularly image data 42. The imaging device 10 can also communicate with other data input devices 40 using various types of network connections and communication schemes (e.g., wire-based, infrared or radio communication).

In order to conserve power, the imaging device 10 changes into a state or mode of low power consumption after a period of inactivity. The period of inactivity is known as a “time-out” period. Thus, the device 10 switches to a low power state only after user 12 interaction has ceased for the duration of a predetermined timeout period, e.g., four minutes. Thus, the display controller 28 can include a time-out function to disable the light source 14.

The wearable display 10 may include both the display 10 and the computing capabilities of device, such as a PDA, to create a wearable computing device smaller than a conventional PDA.

The wearable display 10 may project image data sent to it via short-ranged wired or wireless link from other devices worn by the user 12.

The wearable display 10 may include a frame buffer and controller. Image data can be transmitted only to the display 10, or rather, to the frame buffer, when the displayed image needs to be changed, which minimizes the amount of communication required between the display 10 and the device or devices linked to the display 10.

These and other changes and modifications are intended to be included within the scope of the invention. While for the sake of clarity and ease of description, several specific embodiments of the invention have been described; the scope of the invention is intended to be measured by the claims as set forth below. The description is not intended to be exhaustive or to limit the invention to the form disclosed. Other variations of the invention will be apparent in light of the disclosure and practice of the invention to one of ordinary skill in the art to which the invention applies.

1. An imaging device is adapted to be worn on or about the body of a user, said imaging device comprising:
a light source for emitting a light beam; and
a scanning optical assembly for steering the light beam biaxially onto an external surface, thereby generating an image.

2. The imaging device of claim 1, further comprising a power source, wherein said power source is a battery.

3. The imaging device of claim 1, further comprising a display controller for modulating the light source as the light beam is scanned to create the image.

4. The imaging device of claim 3, wherein the display controller includes a time-out function to disable the light source.

5. A wearable electronic imaging device, comprising a display for projecting an image, said image generated by a scanned laser.

6. The wearable electronic imaging device of claim 5, further comprising a communication interface.

7. The wearable electronic imaging device of claim 6, wherein the communication interface is an image data interface.

8. The wearable electronic imaging device of claim 5, further comprising an interaction interface.

9. The wearable electronic imaging device of claim 8, wherein the interaction interface is a reflective dot attached to a pointing device or a reflective dot adapted to be worn on or about the body of a user, thereby to allow interaction between the image and the user.

10. The wearable electronic imaging device of claim 9, further comprising a display controller for controlling said display and reporting the reflective dot within the projected image.

11. The wearable electronic imaging device of claim 5, further comprising: a housing for containing the display, said housing adapted to be worn on or about the body of a user.

12. The wearable electronic imaging device of claim 5, further comprising a data input device wherein said data input device is external to said display and wherein said data input device is connected to said display.

13. The wearable electronic imaging device of claim 12, wherein said connection is wireless.

14. The wearable electronic imaging device of claim 12, wherein said display is responsive to an output of data from said data input device.

15. The wearable electronic imaging device of claim 5, further comprising a power source, wherein said power source is a battery.

16. The imaging device of claim 5, wherein said image is projected onto an external surface.

17. A method of viewing information with a portable imaging device, said imaging device adapted to be worn by a user, comprising:
providing a light source, said light source emitting a laser beam;
scanning the laser beam biaxially; and
providing a display, said display projecting the laser beam onto an external surface, thereby providing an image viewable to a user.

18. The method of claim 17, further comprising providing a communication interface.

19. The method of claim 18, wherein the communication interface is an image data interface.

20. The method of claim 17, further comprising an interaction interface.

21. The method of claim 20, wherein the interaction interface is a reflective dot attached to a pointing device or a reflective dot adapted to be worn on or about the body of a user, thereby to allow interaction between the image and the user.

22. The method of claim 21, further comprising providing a display controller for controlling said display and reporting the reflective dot within the projected image.

23. The method of claim 17, further comprising providing a power source, wherein said power source is a battery.
